(19) United States
(12) Patent Application Publication
(10) Pub. No.: US 2025/0190552 A1
(43) Pub. Date: Jun. 12, 2025

(54) PROCESS FOR DETECTING AN ATTEMPTED LINEAR EXTRACTION OF THE CONTENT OF A MEMORY

(71) Applicant: INSTITUT MINES TELECOM, Palaiseau (FR)

(72) Inventors: Jean-Max DUTERTRE, Aix en Provence (FR); Théophile GOUSSELOT, Demigny (FR); Jean-Baptiste RIGAUD, Venelles (FR); Olivier POTIN, Carry le Rouet (FR)

(21) Appl. No.: 18/708,922

(22) PCT Filed: Nov. 8, 2022
(86) PCT No.: PCT/EP2022/081057

§ 371 Date: Nov. 25, 2024

(30) Foreign Application Priority Data
Nov. 9, 2021 (EP) 21306569.1
Sep. 22, 2022 (FR) 2209624

(51) Int. Cl. G06F 21/55; G06F 21/54

(52) U.S. Cl. CPC G06F 21/554; G06F 21/54; G06F 21/552

(57) ABSTRACT

“A method for detecting attempted linear extraction of a program code recorded in a memory (10) of an electronic circuit (1) is provided. The program code instructions that, in order to be read by a microprocessor core (14), are loaded sequentially via an instruction bus (11) into an instruction register (12) for storing the instructions that is controlled at least by a clock signal (clk) and a reset signal (reset). Each instruction is loaded into the instruction register (12) on an edge of the clock signal (clk). The discontinuity instructions code and/or what are referred to as “security marker” instructions are inserted among the program instructions so as to be read during the execution of the program. The method includes triggering a predefined alert action (300) in the event of lack of detection of a discontinuity instruction or of a security marker, in accordance with a predefined monitoring rule.

### TECHNICAL FIELD

The present invention relates to a method for detecting attempted linear extraction of the content of a memory of a microcontroller or of a processor, and to an electronic circuit configured to detect such attempted extraction.

### PRIOR ART

Smart card piracy has become a common phenomenon. Since around the early 1990s, almost all types of smart card processors used in European and then American and Asian pay-TV conditional access systems have been successfully redesigned. Illicit clone cards that decrypt television channels without revenue for the broadcaster have been sold. The industry has had to update security processor technology numerous times already, and the challenge is far from over.

The Article by O. Kömmerling et al. “Design Principles for Tamper-Resistant Smartcard Processors” USENIX Workshop on Smartcard Technology, 1999 presents examples of integrated circuit attacks and some countermeasure techniques.

A distinction may be drawn between two major families of attacks: invasive and non-invasive. In the case of a non-invasive attack, the attacked card is not physically damaged and the equipment used in the attack may generally be disguised as a normal smart card reader. With regard to invasive attacks, these are physical attacks based on probing, consisting in accessing the interconnects of the logic part of an integrated circuit with a probe (metal needle positioned on the metal tracks using a micromanipulator).

The probe may be connected to an oscilloscope (via an amplifier if necessary) in order to enable reading of the internal data manipulated by the target circuit.

The probe may also be driven by a signal generator and be used to force an arbitrary logic value on an internal node of the target circuit (for example, to force a circuit into a given non-secure state by setting the value of a control signal).

This attack technique may be passive (for simple eavesdropping purposes) and/or active, and generating an error in the circuit.

An ion gun (focused ion beam, FIB) is generally used to access the interconnects to be probed. The ion gun is a fault analysis instrument used in microelectronics to dig holes in integrated circuits, cut interconnect tracks, and (re)create inter-track electrical contacts.

The doctoral thesis by Dmitry Nedospasov, entitled “Security of the IC backside”, describes invasive attacks, in particular linear code extraction techniques.

The publication by Johannes Obermaier and Vincent Immler, “The past, present, and future of physical security enclosures: From battery-backed monitoring to PUF-based inherent security and beyond”, Journal of Hardware and Systems Security, August 2018, and the publication by Phil Isaacs et al. “Tamper Proof, Tamper Evident Encryption Technology”, Pan Pacific Symposium. SMTA, 2013, set forth examples of countermeasures using a protective enclosure. The program code of a secure circuit comprises multiple portions that are stored in its Flash or ROM memories (it may be executed from a ROM, Flash or RAM memory). This code is protected against replay attacks, failing which the security of the range of secure circuits under consideration may be jeopardized.

Knowing the code makes it possible to develop hardware and software attacks. It is imperative for a manufacturer or a user of a secure circuit to protect the confidentiality of the code, by preventing it from being extracted, or dumped.

For an attacker, linear code extraction consists in replaying the code of a circuit in the correct order from the first memory address to the last (otherwise the code is unusable). Replaying of the code of a circuit is blocked before the code is put on the market. This is why attackers resort to invasive attack techniques to carry out linear code extraction.

It should be noted that linear code extraction may also be used to extract secret keys and other confidential information stored in a circuit.

In the abovementioned thesis, mention is made of some techniques for protecting against linear code extraction, such as burying security-relevant signals in the lower metal layers of the circuit, adding sensors or randomizing the execution of the program with register redundancy, etc.

### SUMMARY OF THE INVENTION

There is a need to further improve methods for detecting attempted linear extraction of the content of an electronic memory, in particular in terms of ease of implementation and efficiency.

### Detection Method

The invention aims to address this objective and, according to one of its aspects, relates to a method for detecting attempted linear extraction of a program code recorded in a memory of an electronic circuit, the code comprising program instructions that, in order to be read by a microprocessor core, are loaded sequentially via an instruction bus into an instruction register for storing the instructions that is controlled at least by a clock signal and a reset signal, each instruction being loaded into the instruction register on an edge of the clock signal, the code comprising discontinuity instructions and/or what are referred to as “security marker” instructions inserted among the program instructions so as to be read during the execution of the program, the method comprising triggering a predefined alert action in the event of lack of detection of a discontinuity instruction or of a security marker, in accordance with a predefined monitoring rule.

The discontinuity instructions are defined as the set of program instructions able to control the program execution flow (conditional and unconditional branching, jump, function call and return, etc.). Generally speaking, a discontinuity instruction interrupts the linear execution of the program, such that execution of this instruction leads to the transition to an instruction having an address that is not consecutive with that of said discontinuity instruction.

“Linear execution” of the program is understood to mean the execution of its instructions in the order of their consecutive memory addresses.

A “security marker” is understood to mean a particular instruction inserted into the code recorded in the memory with a view to protecting it against linear extraction of its content. A security marker has the same structure as the instructions of the instruction set used by the electronic circuit under consideration. The security marker comprises for example 32 bits of information if it is used in circuits using this instruction size.

For an attacker, linear code extraction consists in successively reading the instructions of the code.

Linear code extraction may comprise probing the instruction bus and activating the reset signal so that the microprocessor core reads only null instructions.

By virtue of the invention, it is possible to easily detect such a linear code extraction attack, in particular by detecting the absence of a discontinuity instruction or of a security marker. The predefined monitoring rule may be the lack of detection of a discontinuity instruction or of a security marker for a predefined period and/or after a predefined number of program instructions have been read and/or after a predefined number of clock cycles.

### Security Markers

Preferably, the security markers are inserted into the code with a variable periodicity. This makes them difficult to detect and/or identify for the attacker.

The insertion periodicity of the security markers may be pseudorandom.

The security markers are preferably inserted into the code such that the execution of the program instructions located between two consecutive security markers corresponds to a number of clock cycles less than that leading to the triggering of the predefined alert action.

Two consecutive security markers are preferably arranged such that the number of clock cycles leading to the triggering of the predefined alert action is greater than the maximum number of clock cycles needed to execute the program instructions located between the two security markers.

Indeed, the number of clock cycles needed to execute an instruction may be variable (and in some cases might not be known in advance). The number of clock cycles leading to the triggering of the predefined alert action is thus preferably envisaged for a worst-case scenario, being greater than the maximum number of clock cycles needed to execute program instructions located between two consecutive security markers.

At least one security marker is preferably inserted at the start and at the end of the code of a function forming part of the program.

At least one security marker is preferably inserted at the destination address of a branch instruction.

At least one security marker is preferably inserted at the start or at the end of the code of a loop forming part of the program.

Inserting security markers in the case of a function, a branch or a loop reduces the number of instructions executed between two consecutive security markers and avoids triggering the predefined alert action needlessly.

In one embodiment, the security markers are encoded so as to have at least one particular bit with a significance corresponding to the same significance as that of at least one characteristic bit of a branch instruction, the particular bit having the same encoded value of the characteristic bit, so as to trigger the predefined alert action in the event of an attack based on forcing to the complementary binary value of the characteristic bit.

Indeed, for some instruction encoding (depending on the manufacturer), the branch instructions have a characteristic value on one particular bit.

If considering for example a set of instructions coded on 16 bits (the same reasoning also applies for instructions on 32 and 64 bits), it may be reasoned for example considering that all of the branch instructions have their most significant index bit (bit 15 in this case) at the value 1. However, it is the branch instructions that introduce discontinuities when a code is executed (thereby preventing linear extraction).

An attacker is thus able to carry out an invasive linear code extraction attack by forcing this characteristic bit (bit 15, most significant bit) of the instructions to 0, including the branch instructions when the code is executed. Because this bit is reset to zero, the branch instructions of the code are no longer interpreted as branch instructions. The instruction pointer (intended to contain the memory address of an instruction to be executed) then increments so as to successively read all of the instructions of the code (as long as the characteristic bit is forced to 0). The attacker then does not need to force the instruction register reset signal. Such an attack is suitable a fortiori for the case where the instruction register does not have a reset signal. If the bit-level encoding of a security marker is characterized by a most significant bit at 0, it will not be corrupted by forcing the most significant bit to 0. The detection method is then ineffective against linear extraction based on forcing a bit (allowing the branch instructions to be disabled).

The choice of appropriate encoding of the security marker makes it possible to guarantee the effectiveness of the detection method against forcing of a bit to a given level that leads to a vulnerability.

Picking up on the previous example, choosing encoding of the most significant bit at 1 for the security marker (same value and same characteristic bit as for the branch instructions) ensures that forcing this bit to 0 prevents the security marker from being recognized. In the absence of detection of the security marker, the predefined alert action is thus triggered.

The security markers may be inserted into the code during the compilation phase thereof, the code then being loaded into memory during the programming of the circuit.

As an alternative, the security markers are inserted into the code during the execution thereof, in particular when the program instructions are read from the memory.

In this scenario, the memory contains control logic having a logic block that periodically inserts a security marker among the program instructions when they are read.

In particular, the logic block sends a wait cycle command to the microprocessor core when a security marker is loaded into the instruction register so that the microprocessor core inserts a wait cycle into the execution flow when the security marker is received. In another embodiment, the microprocessor core is configured to recognize a security marker and renew the request to read the instruction, which has been shifted by the insertion of the security marker. This operating mode makes it possible to save on memory space and also allows a simpler implementation of the detection method, since the program does not have to be modified since no security marker is inserted therein.

Preferably, the security markers differ from one another in terms of their payload. This makes it possible to create confusion for the attacker and makes it more difficult to bypass the detection method.

In one embodiment, the program instructions and the security markers are stored in encrypted form in the memory and are decrypted prior to being loaded into the storage register.

### Discontinuity Instructions

Rather than detecting the absence of security markers, it is possible to detect the absence of discontinuity instructions. It is then no longer necessary to include security markers in the code, this resulting in a smaller extension of the execution time compared to using security markers in the program, given that the execution of a security marker requires at least one clock cycle. Moreover, the detection method according to this variant may be applied without modifying the compiler.

In one embodiment, the method comprises, in a step of analyzing the code before it is loaded into the register, inserting at least one linear execution discontinuity instruction into a portion of the code comprising program instructions the execution of which corresponds to a number of clock cycles able to lead to the triggering of the predefined alert action. This makes it possible to avoid triggering a false alarm when there is no attack in progress.

A “linear execution discontinuity instruction” is understood to mean a discontinuity instruction that causes a linear execution of the program. The insertion of the linear execution discontinuity instruction into said code portion thus does not affect the sequential execution of the instructions of this code portion that are located consecutively in the memory.

The linear execution discontinuity instruction may be inserted during the compilation of the code, this instruction being stored in the memory and having a memory address. The linear execution discontinuity instruction then in this case causes a unit incrementation of the memory address of the instructions that follow it.

As an alternative, the linear execution discontinuity instruction is inserted after the instructions to be loaded have been read from the memory and before these instructions are loaded into the instruction register. In this case, the linear execution discontinuity instruction then does not have a memory address, and causes the memory addresses of the instructions that follow it to be retained. This option makes it possible not to modify the compiler, and not to increase memory surface area.

The predefined alert action may comprise at least one of the following actions: resetting the electronic circuit, erasing the memory, resetting the read address in memory to zero, the read address in memory adopting non-consecutive values such that the extraction of the code becomes non-linear, and skipping a section of code, in particular a sensitive section to be protected.

In one embodiment, the detection method is implemented at all times in order to protect the entire program code, the first instruction thereof possibly being a discontinuity instruction or a security marker. In this case, the attack detection logic is activated at all times (and, by design, cannot be disengaged).

In another embodiment, the detection method is implemented in a parameterizable manner via configuration of a fuse, in particular a one-time programmable fuse, or of a variable in non-volatile memory, in particular a Flash or EEPROM memory, in the programming phase of the circuit, the value stored in the fuse or in the non-volatile memory being read when the circuit is started, in particular when it is powered on or when it is woken up after being reset, said value making it possible to activate the detection method, and the first instruction of the program code being a discontinuity instruction or a security marker, if the method is activated. In this case of a parameterizable implementation, the stored value (stored in the fuse or the non-volatile memory) is read when the circuit is started (powered up or woken up after being reset) and makes it possible either to activate the detection method or to keep it inactive. This choice is definitive for the entire duration of use of the circuit.

The detection method may be implemented in order to protect at least a portion of the program code delimited by a start address and an end address, the method being activated as soon as a program instruction the address of which lies between the start address and the end address is read for execution, and being deactivated as soon as a program instruction not belonging to said code portion is read for execution. In this case, the detection method for said at least one code portion is activated at all times and cannot be disengaged, that is to say each time instructions belonging to said code portion are executed, the detection method is activated.

The detection method is applicable to any type of memory that may contain program code with a view to execution thereof by a microprocessor core.

The memory may be embedded in the same integrated circuit as the microprocessor core executing the instructions, for example an embedded Flash or RAM memory, or an external DRAM memory.

### Electronic Circuit

According to another of its aspects, the invention also relates to an electronic circuit comprising at least a memory, a microprocessor core, an instruction bus, a read bus, an address bus and an instruction register for storing instructions that is controlled at least by a clock signal and a reset signal, the memory being connected to the instruction register by the instruction bus, the instruction register being connected to the microprocessor core by the read bus, the microprocessor core comprising an instruction pointer intended to contain the memory address of an instruction to be executed, the microprocessor core being connected to the memory by the address bus, the circuit being configured to detect attempted linear extraction of a program code recorded in the memory, the code comprising program instructions that, in order to be read by the microprocessor core, are loaded sequentially via the instruction bus into the instruction register upon command of the clock signal, the code comprising discontinuity instructions and/or what are referred to as “security marker” instructions inserted among the program instructions so as to be read during the execution of the program, the microprocessor core comprising a protection circuit for protecting against attempted linear extraction, able to trigger a predefined alert action in the event of lack of detection of a discontinuity instruction or of a security marker in accordance with a predefined monitoring rule.

### Loading-of-Instructions or Clock Cycle Counter

The protection circuit preferably comprises a loading-of-instructions or clock cycle counter, the loading-of-instructions or clock cycle counter preferably decreasing, in particular being configured to be decremented upon each loading of an instruction into the instruction register or upon each clock cycle, the loading-of-instructions or clock cycle counter in particular being configured to be periodically reset to a parameterizable value, the loading-of-instructions or clock cycle counter being reset in particular regularly by a security marker before it reaches an alarm threshold, in particular zero, the protection circuit preferably being configured to trigger the predefined alert action when the loading-of-instructions or clock cycle counter reaches the alarm threshold.

### Continuity Instruction Counter

In one embodiment, the circuit according to the invention comprises a continuity instruction counter configured to be decremented upon each execution of a continuity instruction, the continuity instruction counter preferably being configured to be periodically reset to a parameterizable value, the continuity instruction counter being reset regularly by the execution of a discontinuity instruction before it reaches an alarm threshold, in particular zero, the protection circuit being configured to trigger the predefined alert action when the continuity instruction counter reaches the alarm threshold.

A “continuity instruction” is understood to mean an instruction that causes a linear execution of the program and that is not a discontinuity instruction.

The parameterizable reset value of the continuity instruction counter may be set either in an initialization phase that precedes the execution of a program, or on the fly during the execution of the program.

As an alternative, this counter is reset to a value set definitively in the hardware design of the circuit.

If the continuity instruction counter reaches the alarm threshold, an absence of discontinuity instruction is detected, and the predefined alert action is triggered.

As a variant, the continuity instruction counter increases instead of decreasing. The continuity instruction counter may be located in the microprocessor core, in particular in the protection circuit. As an alternative, it is located in the microprocessor core outside the protection circuit. It may also be located outside the microprocessor core, for example between the memory and the core.

It is possible to have multiple counters distributed over various locations. The benefit is that of countering an attack that disables the signal used by the counter so that it remains frozen and is no longer capable of detecting an attack. Using multiple counters with detection of the predefined alert action if the counters adopt different values makes it possible to thwart this kind of attack. Indeed, the multiplicity of counters and their various locations complicates the task for the attacker, who will have to deceive each of the counters.

The information that an instruction has been executed may come from any internal information source: for example, a control signal, a state signal, variations in the instruction address.

### Linear Execution Discontinuity Instruction Insertion Block

The circuit according to the invention may comprise a linear execution discontinuity instruction insertion block, this block being a circuit located outside the memory, communicating therewith and with the instruction register, this block being configured to insert at least one linear execution discontinuity instruction into a portion of the read code comprising program instructions the execution of which corresponds to a number of clock cycles able to lead to the triggering of the predefined alert action. This makes it possible to avoid triggering a false alarm when there is no attack in progress, in particular when the reset value of the continuity instruction counter is fixed, by resetting the counter before the alarm threshold is reached. As an alternative, the linear execution discontinuity instruction insertion block is integrated into the memory.

Analyzing the program before it is loaded into the program memory of the circuit makes it possible to appropriately choose the reset value of the continuity instruction counter if this value is configurable, or to determine the need to insert linear execution discontinuity instructions and where to place them appropriately. If the reset value of the continuity instruction counter is fixed and is not high enough, it is probably useful to insert at least one linear execution discontinuity instruction into code portions containing a lengthy sequence of continuity instructions that is liable to trigger a false alarm. One alternative is to add a linear execution discontinuity instruction insertion hardware block as defined above.

### Linear Execution Discontinuity Instruction Counter

In one embodiment, in addition to the continuity instruction counter, the circuit according to the invention comprises a linear execution discontinuity instruction counter configured to be decremented upon each execution of a linear execution discontinuity instruction, the linear execution discontinuity instruction counter preferably being configured to be periodically reset to a parameterizable value, the linear execution discontinuity instruction counter being reset regularly by the execution of a non-linear execution discontinuity instruction before it reaches an alarm threshold, in particular zero, the protection circuit being configured to trigger the predefined alert action when the linear execution discontinuity instruction counter reaches the alarm threshold.

Of course, a “non-linear execution discontinuity instruction”, as opposed to the linear execution discontinuity instruction, is a discontinuity instruction that leads to a non-linear variation in the instruction address. In other words, the instruction address does not increment in unitary fashion following the execution of the non-linear execution discontinuity instruction.

The parameterizable reset value of the linear execution discontinuity instruction counter may be set either in an initialization phase that precedes the execution of a program, or on the fly during the execution of the program.

As an alternative, the linear execution discontinuity instruction counter is reset to a value set definitively in the hardware design of the circuit.

As a variant, the linear execution discontinuity instruction counter increases instead of decreasing.

The information that an instruction is a discontinuity instruction may come from any internal information source: for example, a control signal, a state signal, variations in the instruction address. In particular, the information that a discontinuity instruction causes a linear execution may ideally come from variations in the instruction address. Nevertheless, this information may be cross-correlated with other information sources: for example, a control signal, a state signal. For example, on the cv32e40p core (RISC-V instruction set), there is a “branch_taken” signal for identifying, when a branch instruction is executed, whether or not execution thereof is linear. If the linear execution discontinuity instruction counter reaches the alarm threshold, an absence of discontinuity instruction causing a non-linear variation in the instruction address is detected, and the predefined alert action is triggered.

The linear execution discontinuity instruction counter makes it possible, inter alia, to detect attacks consisting in injecting into the core only discontinuity instructions that cause a linear execution, for example a branch instruction the condition of which is never met. This type of attack is able to disable the write enable signal (write_enable) of the instruction register so that the instruction contained in the register (which, in this case, is a linear execution discontinuity instruction) is stored there for as long as the write enable signal is disabled. The continuity instruction counter alone will not be able to detect this kind of attack, since it is permanently reset by the stored discontinuity instruction.

The linear execution discontinuity instruction counter also makes it possible to detect attacks consisting in forcing the instruction address to vary linearly, for example an attack consisting in forcing the control signal of the multiplexer supplying the instruction address, so as to select the input that causes a linear variation in the instruction address, regardless of the instruction executed in the core. Indeed, the effect of this attack is that all discontinuity instructions are linear execution discontinuity instructions. The continuity instruction counter alone is not able to detect such an attack, since it is reset upon each discontinuity instruction entering the core. However, the linear execution discontinuity instruction counter will never be reset and will decrement upon each (linear execution) discontinuity instruction, and therefore the attack will be detected.

### Cycle Counter

In addition to the continuity instruction counter, the circuit according to the invention may comprise a cycle counter intended to detect an absence of execution of instructions, configured to increment upon each clock cycle, the cycle counter being reset regularly, in particular to zero, by the execution of an instruction before it reaches an alarm threshold, in particular a parameterizable value, the protection circuit being configured to trigger the predefined alert action when the cycle counter reaches the alarm threshold.

The alarm threshold for this counter may be a threshold defined based on the core specifications, taking into account the maximum number of cycles needed to execute an instruction of the code. If this threshold is reached, an absence of execution of instructions is detected.

The cycle counter resets upon each instruction that is executed (based on the same signal as the one decrementing the continuity instruction counter).

The cycle counter may be used in combination with the continuity instruction counter and possibly the linear execution discontinuity instruction counter.

In the case of an attack that disables the signal containing the information that an instruction has been executed (an internal signal able to be disabled in conjunction with the write enable signal of the instruction register), the continuity instruction counter will not decrement, nor will the linear execution discontinuity instruction counter. Therefore, the continuity instruction counter alone, or in combination with the linear execution discontinuity instruction counter where applicable, is not able to detect this kind of attack. However, the cycle counter will detect the absence of execution of instructions and the predefined alert action will be triggered in order to signal the attack in progress.

### Linear Execution Sequence Length Counter

In one embodiment, the circuit according to the invention comprises a linear execution sequence length counter intended to detect a sequence of linear execution continuity and/or discontinuity instructions of a length exceeding a given length, configured to increment upon each execution of an instruction or upon each clock cycle, the linear execution sequence length counter being reset regularly, in particular to zero, by varying at least one microprocessor core signal indicating the end of execution of a linear execution sequence before it reaches an alarm threshold, the protection circuit being configured to trigger the predefined alert action when the linear execution sequence counter reaches the alarm threshold.

The linear execution sequence length counter makes it possible to detect linear execution sequences of disproportionate length with regard to the instruction set used.

This counter measures the length of linear execution sequences. Indeed, the number of times instructions are loaded linearly from the memory is counted.

The variant with a linear execution sequence length counter no longer requires the addition of new instructions. It involves only detection based on observation. The execution time and the size of the program in memory are thus not changed. The trade-off is that the detection latency of an attack will be greater.

The variant with a linear execution sequence length counter makes it possible, inter alia, to detect all of the attacks described above (activating the reset of the instruction register, storing an instruction in the instruction register, forcing linear variation in the instruction address, etc.). Said at least one microprocessor core signal indicating the end of execution of a linear execution sequence may come from the observation of the read address transmitted by the microprocessor core to the memory.

The alarm threshold may be a parameterizable value or a value set definitively in the hardware design of the circuit. If the threshold is a parameterizable value, it may be set when the program is compiled or on the fly during the execution of the program (the threshold may be adapted to each code portion, so as to ensure low detection latency).

The alarm threshold for the linear execution sequence length counter may be set so as to not cause any detection upon the normal execution of programs representative of the selected instruction set.

If this threshold is reached, a disproportionately lengthy linear execution sequence is detected. As an alternative, the linear execution sequence length counter descends (instead of ascending). In addition to measuring the length of the linear execution sequences based on the variations in the instruction address, it is possible to check the consistency of the variations in the instruction address with the variation in other core signals, for example based on variations in the control signal of the multiplexer supplying the instruction address, a state signal or control signal, etc. The linear execution sequence length counter may have various locations in the circuit.

It may be connected to the instruction address bus. It is thus possible to count the length of a linear execution sequence by reading the address (unit increment when successive addresses follow one another).

The linear execution sequence length counter may be connected to the internal signals of the core. It is thus possible to count the length of a linear execution sequence by observing these signals, for example, for as long as the address multiplexer command is maintained by selecting the “increment the address linearly” input, the linear execution sequence persists.

The linear execution sequence length counter may be connected to the instruction bus. It is thus possible to count the length of a linear execution sequence by observing specific bits of the instruction (for example bits in the funct3 and opcode fields of the code of a RISC-V core instruction) so as to determine whether or not it is a discontinuity instruction.

The memory may be a Flash, ROM, RAM or DRAM memory. In the latter case, the memory is external, that is to say not embedded in the same integrated circuit as the microprocessor core executing the instructions.

The circuit may comprise a decryption circuit located between the memory and the instruction register for decrypting the program instructions and security markers before they are loaded into said register. This applies to the case where the program instructions and security markers are stored in encrypted form in the memory.

In one embodiment, at least one portion of the program code delimited by a start address and an end address is protected against linear extraction by the protection circuit, the start address and end address being stored, when the circuit is programmed, in a non-volatile memory protected against erasure and modification.

The protection circuit preferably comprises registers for loading said start and end addresses, into which said addresses are loaded when the circuit is started, the protection circuit being configured in particular to determine whether the instruction the address of which is contained in the instruction pointer belongs to said at least one code portion by comparing this address with the start and end addresses. If this is the case, the detection method is activated. The choice of the protected code portions may relate for example to the start phase (boot phase) of the circuit and/or to the parts of the code implementing security functions (use of cryptographic tools for example).

In one embodiment, the circuit comprises what is referred to as a “watchdog” circuit that is used to restart the circuit in the event of malfunctioning of the program, the watchdog circuit comprising a watchdog counter incremented on the edge of a clock supplied by an oscillator internal to the circuit, the watchdog circuit being configured in reset mode so as to output a reset to zero signal to the circuit when the watchdog counter reaches a predefined value, the watchdog counter being reset to zero periodically by the execution of an instruction to reset this counter. The circuit may comprise a hardware fuse that enables the watchdog circuit to be activated at all times, such that, when the fuse is blown during programming of the circuit, the watchdog circuit is activated permanently in reset mode.

According to another of its aspects, the invention also relates to the use of the electronic circuit comprising the hardware fuse enabling the watchdog circuit to be activated at all times, the fuse being blown and the watchdog counter reset instructions being used as security markers.

### Protection Method

According to another of its aspects, the invention also relates to a method for protecting a program code, comprising inserting, into this code, discontinuity instructions or security markers for implementing the detection method according to the invention.

In one embodiment, said insertion is carried out during the programming of the code.

In another embodiment, said insertion is carried out during or after the compilation of the code.

As an alternative, said insertion is carried out after reading the instructions to be loaded from the memory storing the code and before these instructions are loaded into the instruction register.

### BRIEF DESCRIPTION OF THE DRAWINGS

The invention will be able to be better understood on reading the following detailed description of non-limiting exemplary implementations thereof, and on examining the appended drawing, in which:

FIG. 1 schematically shows one example of a circuit from the prior art that is not protected against linear extraction of the code contained in the memory of the circuit;

FIG. 2 is a view analogous to FIG. 1, schematically showing one example of a linear code extraction attack;

FIG. 3 is a view similar to FIG. 2, schematically illustrating decryption of the code instructions;

FIG. 4 is a view analogous to FIG. 3, schematically showing a first example of a circuit according to the invention;

FIG. 5 schematically shows a second example of a circuit according to the invention, with modified memory control logic;

FIG. 6 schematically shows one example of a code portion protected according to the invention;

FIG. 7 schematically shows a function call within a code that risks triggering a false alarm;

FIG. 8 is analogous to FIG. 7, with the addition of security markers to avoid triggering a false alarm;

FIG. 9 schematically shows a branch within a code that risks triggering a false alarm;

FIG. 10 is analogous to FIG. 9, with the addition of security markers to avoid triggering a false alarm;

FIG. 11 schematically shows a loop within a code that risks triggering a false alarm;

FIG. 12 is analogous to FIG. 11, with the addition of security markers to avoid triggering a false alarm;

FIG. 13 schematically shows a third example of a circuit according to the invention, in which the instruction register forms part of the microprocessor core;

FIG. 14 schematically illustrates a fourth example of a circuit according to the invention, in which the memory is external;

FIG. 15 shows a fifth example of a circuit according to the invention, identical to that of FIG. 4 but without a decryption circuit;

FIG. 16 schematically illustrates one example of a code portion into which a linear execution discontinuity instruction is inserted;

FIG. 17 schematically shows two examples of code portions into which a linear execution discontinuity instruction is inserted within (example on the right) and outside the memory storing the code (example on the left);

FIG. 18 schematically illustrates a sixth example of a circuit according to the invention, with a continuity instruction counter and a linear execution discontinuity instruction insertion block;

FIG. 19 schematically shows one example of a sequence of instructions to be executed following an attack storing, in the instruction register, a discontinuity instruction that causes a linear execution;

FIG. 20 schematically illustrates a seventh example of a circuit according to the invention with a linear execution discontinuity instruction counter and one example of an attack forcing the control signal of the multiplexer supplying the instruction address;

FIG. 21 schematically shows an eighth example of a circuit according to the invention with a cycle counter and one example of an attack blocking the signal that an instruction has been executed; and

FIG. 22 schematically illustrates a ninth example of a circuit according to the invention, showing various locations of a linear execution sequence length counter.

### DETAILED DESCRIPTION

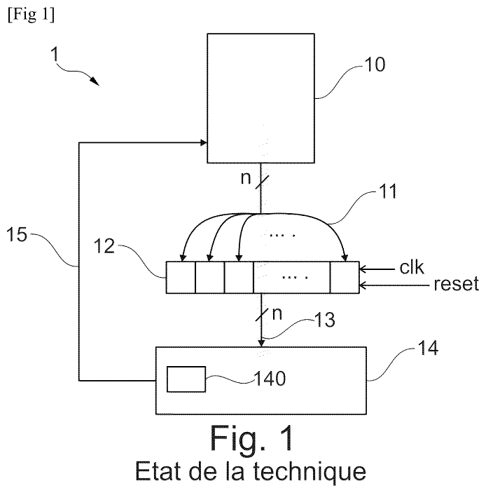

FIG. 1 schematically illustrates an electronic circuit 1 according to the prior art. The circuit 1 comprises a memory 10, a microprocessor core 14, an instruction bus 11, a read bus 13, an address bus 15 and an instruction register 12 for storing instructions, which is controlled by a clock signal clk and a reset signal reset for resetting the content of the instruction register 12 to zero.

The memory 10 is connected to the instruction register 12 by the instruction bus 11.

The memory 10 contains a program code the instructions of which travel from the memory 10, via the instruction bus 11, to be loaded sequentially into the instruction register 12 on an edge of the clock signal clk, for example on the rising edge of the clock.

The instruction register 12 is connected to the microprocessor core 14 by the read bus 13 via which the instruction to be executed travels to the microprocessor core 14.

The microprocessor core 14 comprises an instruction pointer 140 intended to contain the memory address of the instruction to be executed.

The microprocessor core 14 is connected to the memory 10 by the address bus 15. The address bus contains the memory address of the instruction to be executed following the instruction currently being executed.

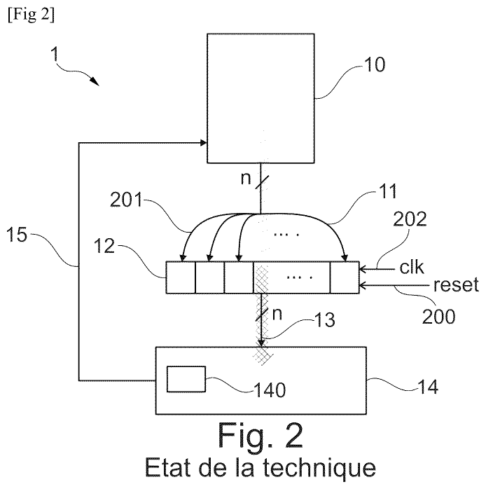

FIG. 2 is a view analogous to FIG. 1, schematically showing one example of a linear extraction attack on the code contained in the memory 10.

In a preliminary step, the attacker has to find the interconnects of the circuit 1. In a first step, the attacker places a probe 200 on the reset signal to force the instruction register 12 to reset to zero. The microprocessor core 14 thus receives null instructions: 00000 . . . 0, which it interprets as no operation (nop) instructions. The microprocessor core 14 therefore transitions to reading the following instruction, and so on. The attacker thereby succeeds in causing linear and progressive reading of the program code contained in the memory 10, instruction by instruction.

In a second step, the attacker finds the interconnects of the instruction bus 11 and places one or more probes 201 thereon. The attacker thus manages to read the code instructions successively and bit by bit.

In an optional third step, the attacker places a probe 202 on the clock signal terminal clk to find out when to read the data on the instruction bus 11.

This is one example of an attack that is extremely difficult to counter since the attacker replaces all of the instructions read from memory with null instructions (nops) in the instruction register 12 by forcing the instruction register 12 to reset to zero.

Moreover, the codes of secure circuits are generally encrypted. However, this does not otherwise protect them against linear extraction using probing, since the code has to be decrypted before it is executed.

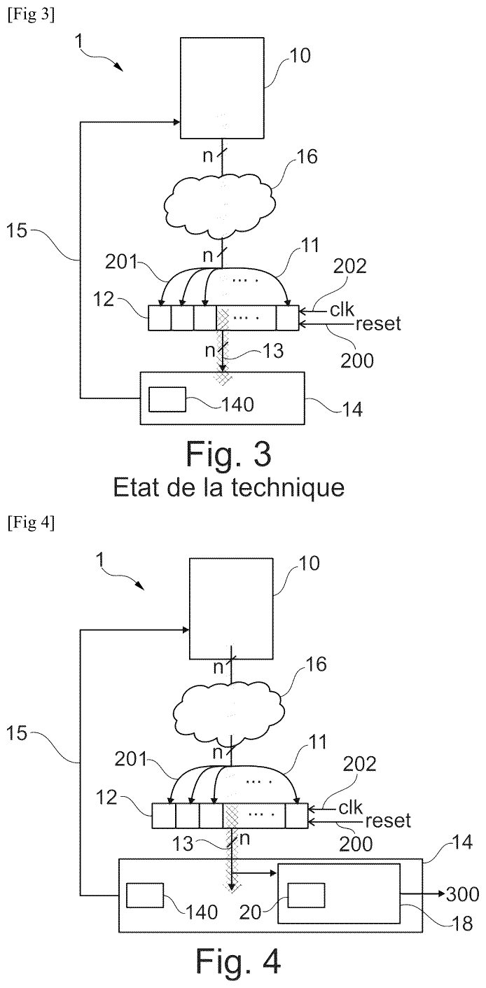

FIG. 3 is a view similar to FIG. 2, schematically illustrating a decryption circuit 16 for decrypting code instructions. As shown in the figure, the probes 200, 201, 202 are placed downstream of the decryption circuit 16, thereby allowing the attacker to read the already decrypted instructions.

FIG. 4 is a view analogous to FIG. 3, schematically showing a first example of a circuit 1 according to the invention.

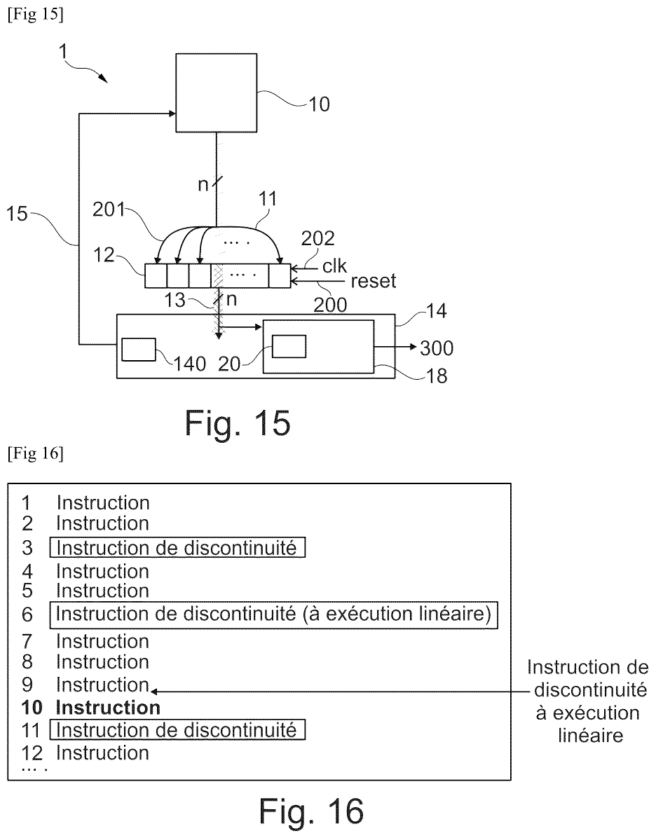

The circuit 1 has the same architecture as that described above, namely a memory 10, a microprocessor core 14, an instruction bus 11, a read bus 13, an address bus 15 and an instruction register 12 for storing instructions, which is controlled by a clock signal clk and a reset signal reset for resetting the content of the instruction register 12 to zero. The decryption circuit 16 remains optional and is present if the instructions are stored in the memory in encrypted form. FIG. 15 illustrates the circuit of FIG. 4 without a decryption circuit 16.

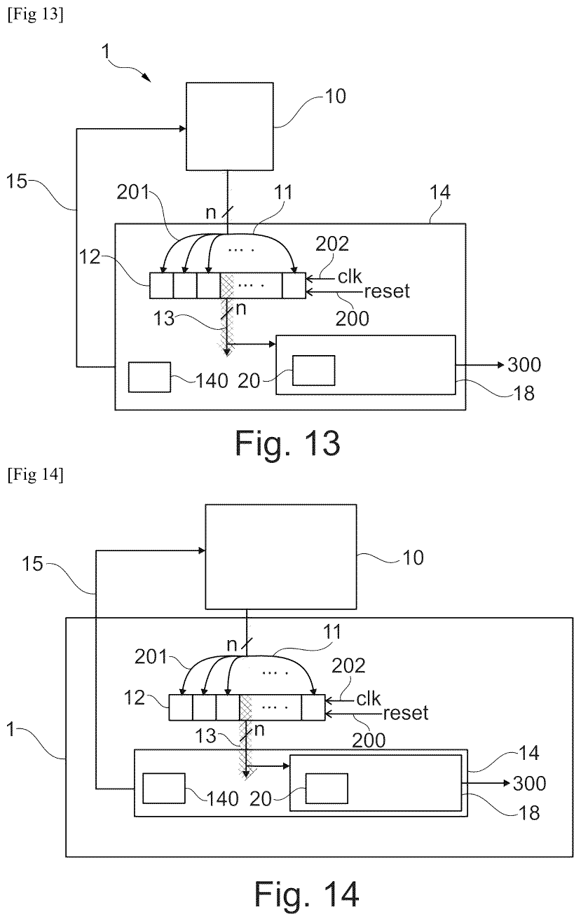

In an embodiment shown in FIG. 13, the instruction register 12 forms part of the microprocessor core 14.

The memory 10 is for example a Flash, ROM, RAM or DRAM memory. In the latter case shown in FIG. 14, the memory 10 is external, that is to say not embedded in the same electronic circuit 1 as the microprocessor core 14 executing the instructions.

The program code recorded in the memory 10 is modified so as to comprise protection instructions referred to as “security markers” that are inserted among the program instructions so as to be read during the execution of the program. For example, the security markers are inserted into the code with a variable periodicity so as to make them difficult to detect and/or identify. In order to deceive an observer and make it even more complicated to detect and/or identify the security markers, these may differ from one another, in particular in terms of their payload.

The microprocessor core 14 comprises a protection circuit 18 for protecting against attempted linear extraction, which is able to trigger a predefined alert action 300 in the event of lack of detection of a security marker in accordance with a predefined monitoring rule. The predefined monitoring rule may be the lack of detection of a security marker for a predefined period and/or after a predefined number of program instructions have been read. The protection circuit 18 comprises for example, as illustrated, a decreasing loading-of-instructions or clock cycle counter 20, configured to be decremented upon each loading of an instruction into the instruction register 12 or upon each clock cycle, and which is periodically reset to a parameterizable positive value.

The loading-of-instructions or clock cycle counter 20 is reset regularly by a security marker before it reaches zero. If the loading-of-instructions or clock cycle counter 20 reaches zero, the protection circuit 18 is configured to trigger the predefined alert action 300.

As an alternative, the loading-of-instructions or clock cycle counter 20 may be incremented starting from zero, in which case the predefined alert action 300 is triggered when the loading-of-instructions or clock cycle counter 20 reaches a predefined (optionally parameterizable) value. The predefined parameterizable value may be a value contained in the payload of the previously executed security marker.

The predefined alert action 300 may be: resetting the circuit 1, erasing the memory 10, resetting the read address in memory to zero (in which case the attacker reads the same short initial instruction sequence indefinitely), assigning the read address in memory inconsistent non-consecutive values, in particular by loading a random value into the address register in memory upon each clock cycle (in which case the code extraction becomes non-linear), skipping a section of code, in particular a sensitive section to be protected (in which case the attacker extracts a useless code), etc.

The security markers may be inserted into the code during the compilation phase thereof, the code then being loaded into memory during the programming of the circuit.

As an alternative, the security markers are inserted into the code during the execution thereof, in particular when the program instructions are read from the memory.

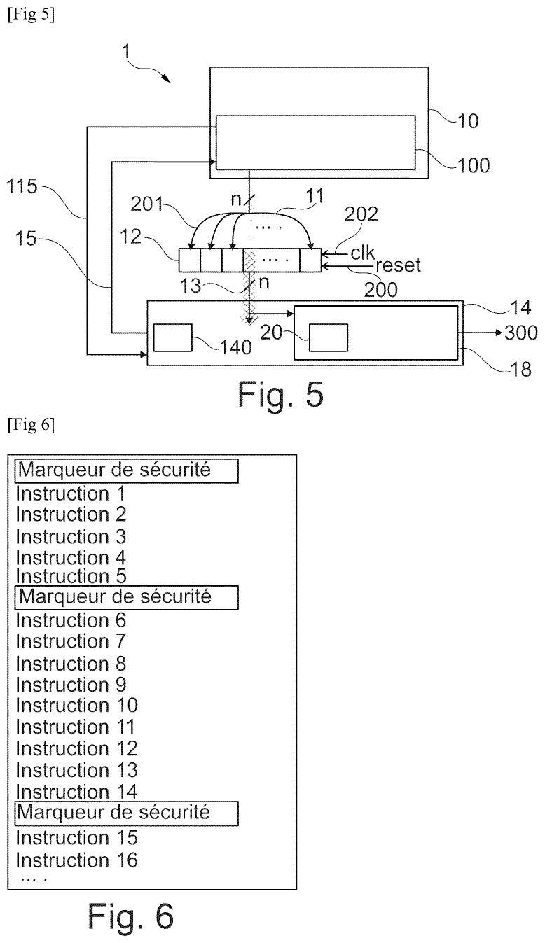

This embodiment is shown in FIG. 5, where the memory 10 contains control logic having a logic block 100 that periodically inserts a security marker among the program instructions when they are read. In this case, the code stored in the memory 10 does not comprise a security marker, and the control logic of the memory is modified so as to insert the security markers on the fly when the program instructions are read from the memory.

The logic block 100 sends a wait cycle command 115 to the microprocessor core 14 when a security marker is loaded into the instruction register 12 so that the microprocessor core 14 inserts a wait cycle into the execution flow when the security marker is received. The microprocessor core 14 is thus warned about the reception of a security marker rather than of the instruction the address of which it supplied via the address bus 15.

FIG. 6 illustrates a schematic example of a portion of code protected according to the invention.

The security markers are preferably inserted into the code with a variable periodicity, such that the execution of the program instructions located between two consecutive security markers corresponds to a number of clock cycles less than that leading to the triggering of the predefined alert action.

It should be noted that the number of clock cycles needed to execute an instruction may be variable (and in some cases might not be known in advance). The number of clock cycles leading to the triggering of the predefined alert action is therefore preferably envisaged for a worst-case scenario, being greater than the maximum number of clock cycles needed to execute program instructions located between two consecutive security markers.

Like any binary instruction, a security marker essentially comprises two fields: the opcode, which makes it possible to identify the marker, and the payload, which may for example be varied to deceive an observer, making it very difficult to bypass the detection of the attack. For example, it is possible, in the payload, to set the initial value adopted by the counter or to impose a payload value according to a particular logic (increasing, decreasing, alternating, unique value, etc.) in order to introduce variability for deceiving the attacker. Indeed, the usefulness of the payload is that of optionally being able to vary the maximum number of clock cycles to be complied with between two security markers, failing which the predefined alert action will be triggered.

Moreover, if a program code comprises special instructions such as a function call, a branch (jump), a loop, etc., the security markers should be inserted while taking care not to trigger a false alarm.

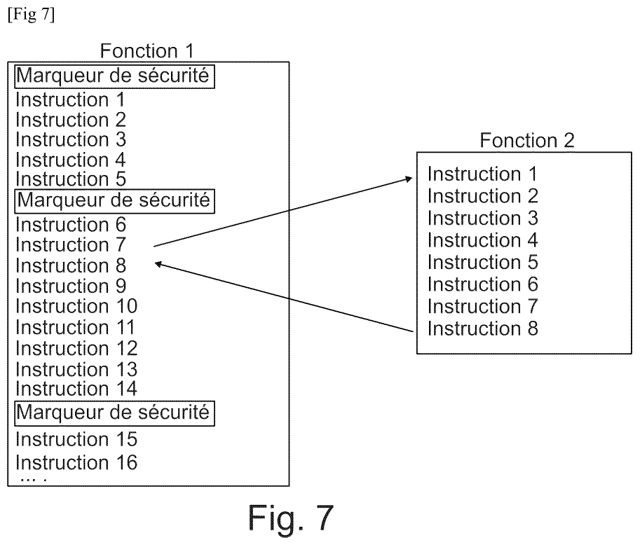

FIG. 7 schematically shows a function call within a code of this type.

The function 2 is embedded in the “Function 1” code and is called between instructions 7 and 8.

Executing function 2 leads to an increase in the number of instructions executed (and therefore in the number of clock cycles elapsed) between two security markers, at the risk of triggering the predefined alert action 300 needlessly if no precautions are taken.

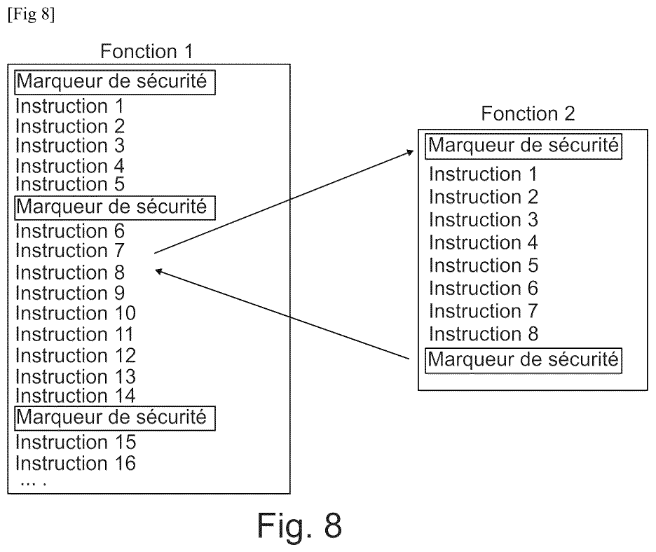

One solution to this problem is illustrated in FIG. 8, where two security markers are added to the start and the end of the function 2 code, respectively, thus reducing the number of clock cycles separating two security markers to below the activation threshold for the predefined alert action 300.

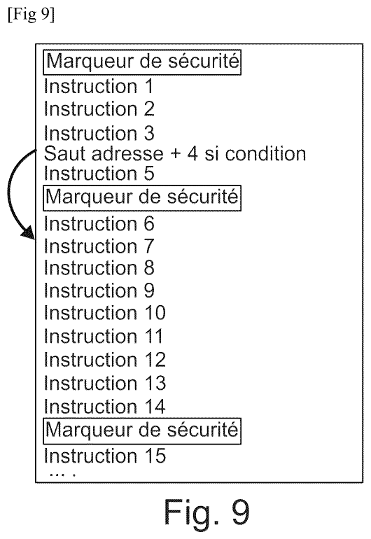

FIG. 9 schematically shows a branch within a code that risks triggering a false alarm. In the example illustrated, the branch is carried out from instruction 3 to instruction 7, that is to say a jump of 4 addresses.

Upon execution, the jump instruction prevents the execution of the security marker placed before instruction 6. This leads to an increase in the number of instructions executed (and therefore in the number of clock cycles elapsed) between two security markers, at the risk of triggering the predefined alert action 300 needlessly.

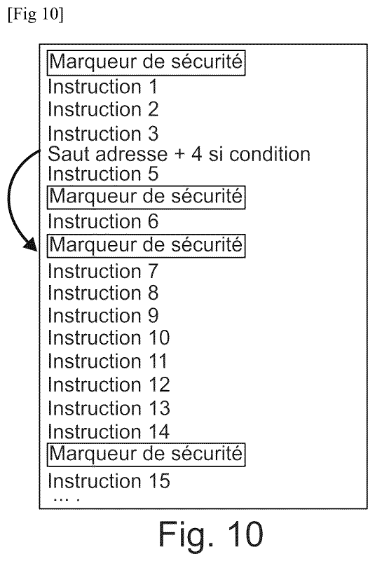

One solution to this problem is illustrated in FIG. 10, where a security marker is inserted at the destination address of the branch instruction.

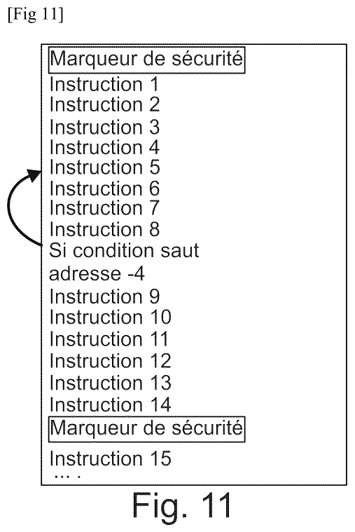

FIG. 11 schematically shows a loop within a code that risks triggering a false alarm. In the example illustrated, the validity of a condition following instruction 8 loops the reading back to the address of instruction 5 (this corresponding to a jump of 4 addresses back).

In fact, the loop is executed for as long as the condition is verified, each time instructions 5 to 8 are executed again, leading to an increase in the number of instructions executed (and therefore in the number of clock cycles elapsed) between two security markers, at the risk of triggering the predefined alert action 300 needlessly.

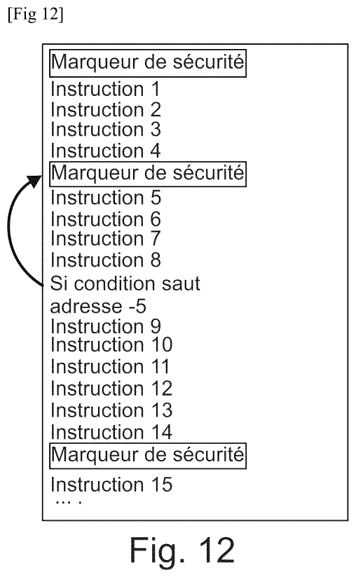

One solution to this problem is illustrated in FIG. 12, where a security marker is added at the head of the loop. The jump to the start of the loop corresponds, in this case, to 5 addresses back. As an alternative, the security marker may be added at the end of the loop.

Without having to add security markers into the code, it is also possible to detect the absence of discontinuity instructions according to the same principle.

Indeed, rather than having a loading-of-instructions or clock cycle counter 20, the circuit 1, in particular the protection circuit 18 of the microprocessor 14, may comprise a continuity instruction counter 21, as illustrated in FIG. 18. This counter 21 may be configured to be decremented upon each execution of a continuity instruction, the continuity instruction counter 21 preferably being configured to be periodically reset to a parameterizable value, the continuity instruction counter 21 being reset regularly by the execution of a discontinuity instruction before it reaches an alarm threshold, in particular zero, the protection circuit 18 being configured to trigger the predefined alert action 300 when the continuity instruction counter 21 reaches the alarm threshold.

If considering the example of the code portion shown in FIG. 16 and taking a decreasing continuity instruction counter 21 set to 4 and having an alarm threshold of zero as an example, this counter will be reset by the linear execution discontinuity instruction at address 6. It will decrease when instructions 7 to 10 are executed, and will reach zero upon execution of instruction 10, which will trigger a false alarm since there is no attack. To avoid this, it is useful either to increase the initial value of the counter 21 or to insert a linear execution discontinuity instruction between program instructions 7 to 10, the execution of which corresponds to a number of clock cycles that may lead to needless triggering of the predefined alert action. In this case, the linear execution discontinuity instruction is inserted between instructions 9 and 10.

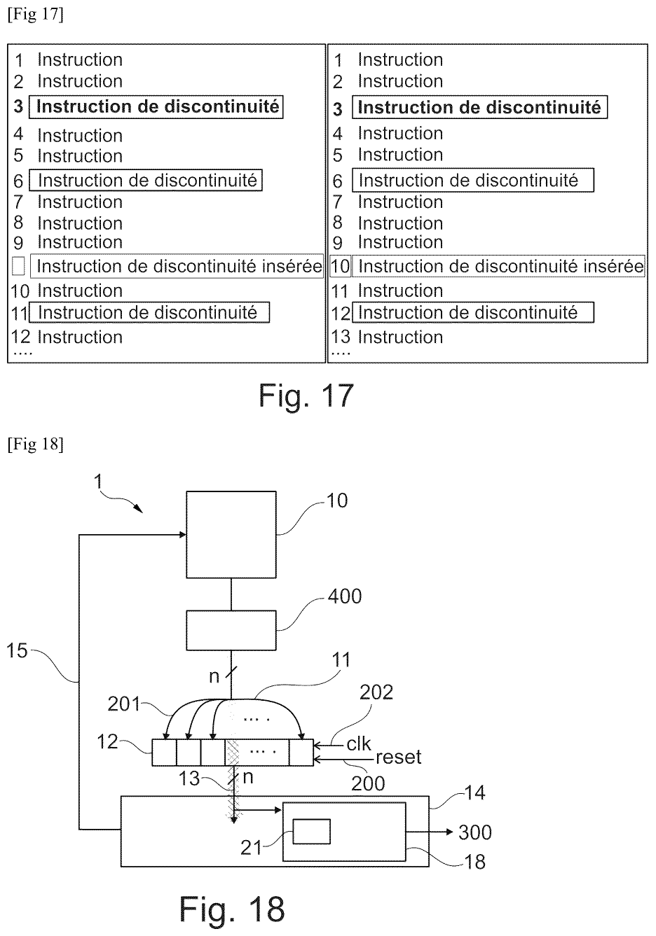

FIG. 17 shows two possibilities for inserting a linear execution discontinuity instruction into the code portion of FIG. 16: either during the compilation of the code (on the right in FIG. 17) or outside the memory and before the instructions are loaded into the instruction register (on the left in FIG. 17).

When the linear execution discontinuity instruction is inserted during the compilation of the code, it is stored in the memory and has a memory address. In the example illustrated on the right in FIG. 17, the linear execution discontinuity instruction is inserted between instructions 9 and 10. It then adopts memory address 10 and in this case leads to unit incrementation of the memory address of the instructions that follow it, as shown on the right in FIG. 17.

When the linear execution discontinuity instruction is inserted outside the memory and before the instructions are loaded into the instruction register, it then does not have a memory address in this case, and causes the memory addresses of the instructions that follow it to be retained. On the left in FIG. 17, the linear execution discontinuity instruction is inserted between instructions 9 and 10 while the microprocessor core is waiting to receive instruction 10. It therefore receives the discontinuity instruction instead of instruction 10, in order to avoid the unwanted triggering of an alarm. A mechanism is then triggered that causes the core to continue to request instruction 10. The core is for example configured to recognize a linear execution discontinuity instruction and renew the request to read instruction 10, which was shifted by the insertion of the linear execution discontinuity instruction. The core eventually receives instruction 10 in order to execute it. In this case, the various instructions keep their memory addresses. The discontinuity instruction was inserted into the flow of instructions read from the memory with a view to being executed by the core.

FIG. 18 schematically shows a linear execution discontinuity instruction insertion block 400, which is a circuit located outside the memory 10, communicating therewith and with the instruction register 12. This variant makes it possible not to modify the compiler, and not to increase memory surface area.

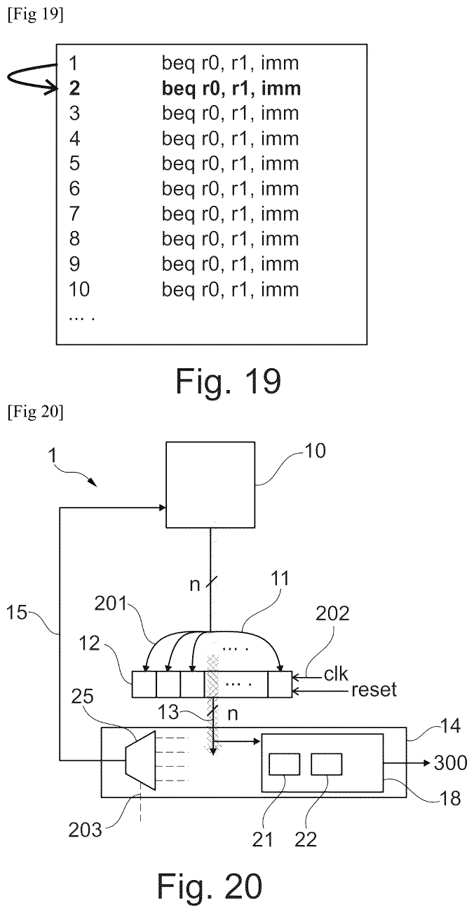

FIG. 19 schematically shows one example of a sequence of instructions to be executed following an attack storing, in the instruction register, a discontinuity instruction that causes a linear execution. In this case, this is a branch instruction the condition of which is never met: beq r0, r1, imm (beq meaning “branch if equal”). Since the registers r0 and r1 are different, the branch to the address imm will never take place. This type of attack disables the write enable signal (write_enable) of the instruction register 12 so that the instruction contained in the register (beq R0, r1, imm, which, in this case, is a linear execution discontinuity instruction) is stored there for as long as the disabling of write enable signal persists. The continuity instruction counter 21 alone will not be able to detect this kind of attack, since it is permanently reset by the stored discontinuity instruction (beq r0, r1, imm).

A linear execution discontinuity instruction counter 22 (shown in FIG. 20) thus makes it possible, inter alia, to detect this kind of attack consisting in injecting, into the core, only discontinuity instructions that cause a linear execution. In addition to the continuity instruction counter 21, the circuit 1, in particular the protection circuit 18, may comprise a linear execution discontinuity instruction counter 22 configured to be decremented upon each execution of a linear execution discontinuity instruction, the linear execution discontinuity instruction counter 22 preferably being configured to be periodically reset to a parameterizable value, the linear execution discontinuity instruction counter 22 being reset regularly by the execution of a non-linear execution discontinuity instruction before it reaches an alarm threshold, in particular zero, the protection circuit 18 being configured to trigger the predefined alert action 300 when the linear execution discontinuity instruction counter 22 reaches the alarm threshold.

Let us take an example with the code portion of FIG. 19, a decreasing continuity instruction counter 21, set to 4, and a decreasing linear execution discontinuity instruction counter 22, set to 8, the alarm thresholds of both counters being zero. The counter 21 will be reset to 4 upon each “beq R0, r1, imm” instruction and will not decrease, whereas the counter 22 will decrement upon each instruction until that of address 9, where it will reach its alarm threshold, causing the triggering of the predefined alert action.

The combination of counters 21 and 22 also makes it possible to counter another type of attack consisting in forcing the instruction address to vary linearly. FIG. 20 schematically illustrates one example of such an attack. The control signal 203 of a multiplexer 25 contained in the core 14 and supplying the instruction address is forced so as to select the input that causes a linear variation in the instruction address.

Thus, regardless of the instruction (continuity or discontinuity), it will always be a linear execution instruction. The continuity instruction counter 21 alone is not able to detect such an attack, since it is reset upon each discontinuity instruction entering the core. However, the linear execution discontinuity instruction counter 22 will never be reset and will decrement upon each (linear execution) discontinuity instruction, and therefore the attack will be detected.

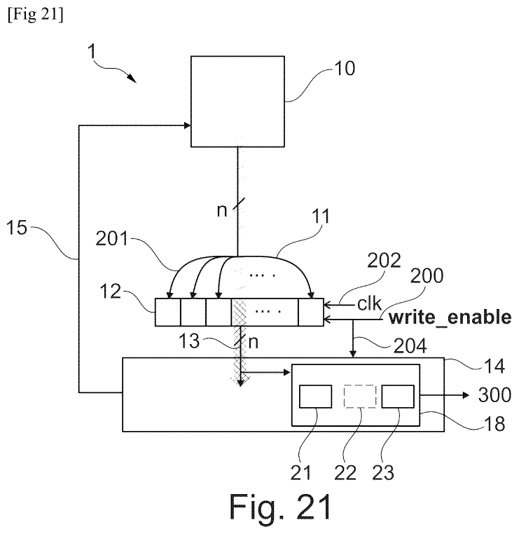

FIG. 21 illustrates the case of an attack disabling the signal 204 containing the information that an instruction has been executed, an internal signal 204 able to be disabled in conjunction with the write enable signal write_enable of the instruction register (the probe 200 is no longer placed on the reset, which has not been shown for the sake of simplification, but on the write_enable signal of the instruction register 12). In this case, the continuity instruction counter 21 will not decrement, nor will the linear execution discontinuity instruction counter 22. Therefore, the continuity instruction counter 21 alone, or in combination with the linear execution discontinuity instruction counter 22 where applicable, is not able to detect this kind of attack, hence the benefit of having a cycle counter 23 able to detect the absence of execution of instructions.

The circuit 1, in particular the protection circuit 18, may therefore comprise a cycle counter 23 intended to detect an absence of execution of instructions, the counter 23 being configured to increment upon each clock cycle, the cycle counter 23 being reset regularly, in particular to zero, by the execution of an instruction before it reaches an alarm threshold, in particular a parameterizable value, the protection circuit 18 being configured to trigger the predefined alert action 300 when the cycle counter 23 reaches the alarm threshold.

The cycle counter 23 may be used in combination with the continuity instruction counter 21 and optionally the linear execution discontinuity instruction counter 22 (shown in dotted lines in FIG. 21 to indicate that it is optional).

Moreover, in another embodiment, it is possible to detect linear execution sequences of disproportionate length with regard to the instruction set used, by way of a linear execution sequence length counter 24.

The circuit 1 may therefore comprise a linear execution sequence length counter 24 intended to detect a sequence of linear execution continuity instructions and/or discontinuity instructions of a length exceeding a given length, configured to increment upon each execution of an instruction or upon each clock cycle, the linear execution sequence length counter 24 being reset regularly, in particular to zero, by varying at least one microprocessor core 14 signal indicating the end of execution of a linear execution sequence before it reaches an alarm threshold, the protection circuit 18 being configured to trigger the predefined alert action when the linear execution sequence counter reaches the alarm threshold.

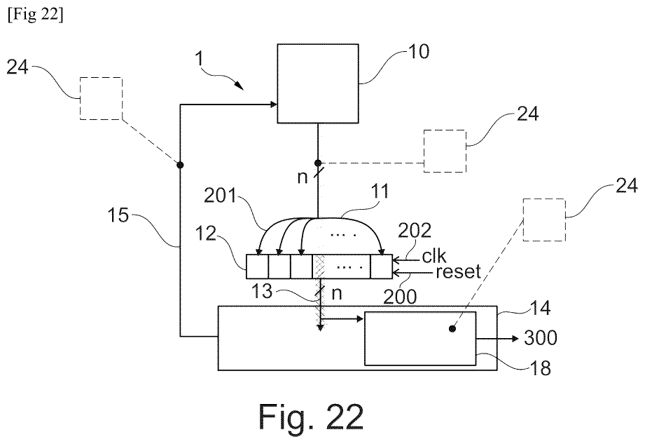

This variant with a linear execution sequence length counter makes it possible, inter alia, to detect all of the attacks described above (activating the reset of the instruction register, storing an instruction in the instruction register, forcing linear variation in the instruction address, etc.). The linear execution sequence length counter 24 may have various locations in the circuit 1, as shown in FIG. 22.

It may be connected to the instruction address bus 15. It is thus possible to count the length of a linear execution sequence by reading the address (unit increment when successive addresses follow one another).

The linear execution sequence length counter 24 may be connected to the internal signals of the core. It is thus possible to count the length of a linear execution sequence by observing these signals, for example, for as long as the address multiplexer command is maintained by selecting the “increment the address linearly” input, the linear execution sequence persists.

The linear execution sequence length counter 24 may be connected to the instruction bus 12. It is thus possible to count the length of a linear execution sequence by observing specific bits of the instruction (for example bits in the funct3 and opcode fields of the code of a RISC-V core instruction) so as to determine whether or not it is a discontinuity instruction.

The variants described above in FIG. 13 (instruction register forming part of the microprocessor core) and FIG. 14 (external memory) may be reproduced on embodiments aimed at detecting an absence of a discontinuity instruction rather than a security marker. One example of a field of application for the present invention is the protection of secure circuits (for example smart cards, secure microcontrollers, etc.) against extraction of their program and sensitive data that they contain (cryptographic keys, various rights, etc.).

One example of a market affected by linear code extraction is that of ink cartridges for printers (linear extraction of the code of manufacturers' cartridges to sell compatible copies thereof), which may therefore be protected by a chip secured according to the invention.

The invention is not limited to the exemplary embodiments described above. For example, it is possible to implement the detection method according to the invention purely on a software basis by implementing it in what are referred to as watchdog microcontrollers, in particular real-time watchdog microcontrollers, by using the intrinsic reset to zero mechanism of the watchdog circuit. The counters described above may be increasing, decreasing, or any other variant.

1. A method for detecting attempted linear extraction of a program code recorded in a memory of an electronic circuit, the code having program instructions that, in order to be read by a microprocessor core, are loaded sequentially via an instruction bus into an instruction register for storing the instructions that is controlled at least by a clock signal and a reset signal, each instruction being loaded into the instruction register on an edge of the clock signal, the code having discontinuity instructions and/or what are referred to as “security marker” instructions inserted among the program instructions so as to be read during the execution of the program,
the method comprising the steps of
triggering a predefined alert action in the event of lack of detection of a discontinuity instruction or of a security marker, in accordance with a predefined monitoring rule.

2. The method as claimed in claim 1, the predefined monitoring rule being the lack of detection of a discontinuity instruction or of a security marker for a predefined period and/or after a predefined number of program instructions have been read and/or after a predefined number of clock cycles.

3. The method as claimed in claim 1, the security markers being inserted into the code with a variable periodicity and/or the security markers being inserted into the code such that the execution of program instructions located between two consecutive security markers corresponds to a number of clock cycles less than that leading to the triggering of the predefined alert action, two consecutive security markers preferably being arranged such that the number of clock cycles leading to the triggering of the predefined alert action is greater than the maximum number of clock cycles needed to execute the program instructions located between the two security markers.

4. The method as claimed in claim 1, at least one security marker being inserted at the start and at the end of the code of a function forming part of the program and/or at least one security marker being inserted at the destination address of a branch instruction and/or at least one security marker being inserted at the start or at the end of the code of a loop forming part of the program.

5. The method as claimed in claim 1, the security markers being encoded so as to have at least one particular bit with a significance corresponding to the same significance as that of at least one characteristic bit of a branch instruction, the particular bit having the same encoded value of the characteristic bit, so as to trigger the predefined alert action in the event of an attack based on forcing to the complementary binary value of the characteristic bit.

6. The method as claimed in claim 1, the security markers being inserted into the code during the execution thereof, in particular when the program instructions are read from the memory, the memory preferably containing control logic having a logic block that periodically inserts a security marker among the program instructions when they are read, the logic block in particular transmitting a wait cycle command to the microprocessor core when a security marker is loaded into the instruction register so that the microprocessor core inserts a wait cycle into the execution flow when the security marker is received.

7. The method as claimed in claim 1, the security markers differing from one another in terms of their payload.

8. The method as claimed in claim 1, comprising, in a step of analyzing the code before it is loaded into the register, inserting at least one linear execution discontinuity instruction into a portion of the code comprising program instructions the execution of which corresponds to a number of clock cycles able to lead to the triggering of the predefined alert action.

9. The method as claimed in claim 8, the linear execution discontinuity instruction being inserted during the compilation of the code, this instruction being stored in the memory and having a memory address.

10. The method as claimed in claim 8, the linear execution discontinuity instruction being inserted after the instructions to be loaded have been read from the memory and before these instructions are loaded into the instruction register.

11. The method as claimed in claim 1, the predefined alert action comprising at least one of the following actions: resetting the electronic circuit, erasing the memory, resetting the read address in memory to zero, the read address in memory adopting non-consecutive values such that the extraction of the code becomes non-linear, and skipping a section of code, in particular a sensitive section to be protected.

12. The method as claimed in claim 1, being implemented at all times in order to protect the entire program code, the first instruction thereof in particular being a discontinuity instruction or a security marker.

13. The method as claimed in claim 1, being implemented in a parameterizable manner via configuration of a fuse, in particular a one-time programmable fuse, or of a variable in non-volatile memory, in particular a Flash or EEPROM memory, in the programming phase of the circuit, the value stored in the fuse or in the non-volatile memory being read when the circuit is started, in particular when it is powered on or when it is woken up after being reset, said value making it possible to activate the detection method, and the first instruction of the program code being a discontinuity instruction or a security marker, if the method is activated.

14. The method as claimed in claim 1, being implemented in order to protect at least a portion of the program code delimited by a start address and an end address, the method being activated as soon as a program instruction the address of which lies between the start address and the end address is read for execution, and being deactivated as soon as a program instruction not belonging to said code portion is read for execution, said code portion corresponding in particular to the start phase of the circuit or a portion of code implementing security functions, in particular cryptographic tools.

15. An electronic circuit comprising:
at least a memory, a microprocessor core, an instruction bus, a read bus, an address bus and an instruction register for storing instructions that is controlled at least by a clock signal and a reset signal, the memory being connected to the instruction register by the instruction bus, the instruction register being connected to the microprocessor core by the read bus, the microprocessor core comprising an instruction pointer intended to contain the memory address of an instruction to be executed, the microprocessor core being connected to the memory by the address bus, the circuit being configured to detect attempted linear extraction of a program code recorded in the memory, the code comprising program instructions that, in order to be read by the microprocessor core, are loaded sequentially via the instruction bus into the instruction register upon command of the clock signal, the code comprising discontinuity instructions and/or what are referred to as “security marker” instructions inserted among the program instructions so as to be read during the execution of the program, the microprocessor core comprising a protection circuit for protecting against attempted linear extraction, able to trigger a predefined alert action in the event of lack of detection of a discontinuity instruction or of a security marker in accordance with a predefined monitoring rule.

16. The circuit as claimed in the preceding claim 15, at least one portion of the program code delimited by a start address and an end address being protected against linear extraction by the protection circuit, the start address and end address being stored, when the circuit is programmed, in a non-volatile memory protected against erasure and modification, the protection circuit preferably comprising registers for loading said start and end addresses, into which said addresses are loaded when the circuit is started, the protection circuit being configured in particular to determine whether the instruction the address of which is contained in the instruction pointer belongs to said at least one code portion by comparing this address with the start and end addresses.

17. The circuit as claimed in claim 15, comprising what is referred to as a “watchdog” circuit that is used to restart the circuit in the event of malfunctioning of the program, the watchdog circuit comprising a watchdog counter incremented on the edge of a clock supplied by an oscillator internal to the circuit, the watchdog circuit being configured in reset mode so as to output a reset to zero signal to the circuit when the watchdog counter reaches a predefined value, the watchdog counter being reset to zero periodically by the execution of an instruction to reset this counter.

18. The circuit as claimed in claim 17, comprising a hardware fuse enabling the watchdog circuit to be activated at all times, such that, when the fuse is blown during programming of the circuit, the watchdog circuit is permanently activated in reset mode.

19. The use of the circuit as claimed in claim 18, the fuse being blown and the watchdog counter reset instructions being used as security markers.

20. The circuit as claimed in claim 15, the protection circuit comprising a loading-of-instructions or clock cycle counter, configured to be decremented upon each loading of an instruction into the instruction register or upon each clock cycle, the loading-of-instructions or clock cycle counter being configured to be periodically reset to a parameterizable value, the loading-of-instructions or clock cycle counter being reset regularly by a security marker before it reaches an alarm threshold, in particular zero, the protection circuit being configured to trigger the predefined alert action when the loading-of-instructions or clock cycle counter reaches the alarm threshold.

21. The circuit as claimed in claim 15, comprising a continuity instruction counter configured to be decremented upon each execution of a continuity instruction, the continuity instruction counter preferably being configured to be periodically reset to a parameterizable value, the continuity instruction counter being reset regularly by the execution of a discontinuity instruction before it reaches an alarm threshold, in particular zero, the protection circuit being configured to trigger the predefined alert action when the continuity instruction counter reaches the alarm threshold.

22. The circuit as claimed in claim 15, comprising a linear execution discontinuity instruction insertion block, which is a circuit located outside the memory, communicating therewith and with the instruction register, the block being configured to insert at least one linear execution discontinuity instruction into a portion of the read code comprising program instructions the execution of which corresponds to a number of clock cycles able to lead to the triggering of the predefined alert action.

23. The circuit as claimed in claim 21, comprising a linear execution discontinuity instruction counter configured to be decremented upon each execution of a linear execution discontinuity instruction, the linear execution discontinuity instruction counter preferably being configured to be periodically reset to a parameterizable value, the linear execution discontinuity instruction counter being reset regularly by the execution of a non-linear execution discontinuity instruction before it reaches an alarm threshold, in particular zero, the protection circuit being configured to trigger the predefined alert action when the linear execution discontinuity instruction counter reaches the alarm threshold.

24. The circuit as claimed in claim 21, comprising a cycle counter intended to detect an absence of execution of instructions, configured to increment upon each clock cycle, the cycle counter being reset regularly, in particular to zero, by the execution of an instruction before it reaches an alarm threshold, in particular a parameterizable value, the protection circuit being configured to trigger the predefined alert action when the cycle counter reaches the alarm threshold.

25. The circuit as claimed in claim 15, comprising a linear execution sequence length counter intended to detect a sequence of linear execution continuity instructions and/or discontinuity instructions of a length exceeding a given length, configured to increment upon each execution of an instruction or upon each clock cycle, the linear execution sequence length counter being reset regularly, in particular to zero, by varying at least one microprocessor core signal indicating the end of execution of a linear execution sequence before it reaches an alarm threshold, the protection circuit being configured to trigger the predefined alert action when the linear execution sequence counter reaches the alarm threshold.

26. A method for protecting a program code, comprising inserting, into this code, discontinuity instructions or security markers for implementing the method as claimed in claim 1.

27. The method as claimed in claim 26, said insertion being carried out during the programming of the code.

28. The method as claimed in claim 26, said insertion being carried out during or after the compilation of the code.

29. The method as claimed in claim 26, said insertion being carried out after reading the instructions to be loaded from the memory storing the code and before these instructions are loaded into the instruction register.
